(19) United States
(12) Patent Application Publication
(10) Pub. No.: US 2023/0376277 A1
(43) Pub. Date: Nov. 23, 2023

(54) QUANTUM RANDOM NUMBER GENERATION USING PHOTON SHOT NOISE SOURCES

(71) Applicant: SOCIETY FOR ELECTRONIC TRANSACTIONS AND SECURITY (SETS), Chennai (IN)

(72) Inventors: Natarajan VENKATACHALAM, Coimbatore (IN); Swathi Mithran MANIVANAN, Chennai (IN); Nelaturu Sarat Chandra BABU, Chennai (IN)

(73) Assignee: SOCIETY FOR ELECTRONIC TRANSACTIONS AND SECURITY (SETS), Chennai (IN)

(21) Appl. No.: 18/197,588

(22) Filed: May 15, 2023

(30) Foreign Application Priority Data
May 18, 2022 (IN) 202241028716

(51) Int. Cl. G06F 7/58

(52) U.S. Cl. CPC G06F 7/58

(57) ABSTRACT

A system and method for secure and reliable generation of quantum random numbers based on various untrusted shot noise sources of quantum nature. The system includes multisource quantum shot noise harvesting circuit and a randomness extraction module to extract entropy of quantum origin from emitted noisy data and randomness amplification. The noise harvesting circuit includes a data acquisition module to collect and store the noise signals emitted by the untrusted sources. The randomness extraction module is configured to perform tensor and permutation circuitry operation on the received data and yields the quantum random sequences. The system includes a randomness amplification module configured to apply multiplication operation on several quantum random sequences to produce pseudo random sequences. The system includes an oracle verification module to verify and certify the output random sequences of quantum origin.

### FIELD OF THE INVENTION

The present disclosure generally relates to random number generation and more specifically relates to secure and reliable system and method for quantum random number generation using various untrusted shot noise sources of quantum nature.

### BACKGROUND OF THE INVENTION

Random number generators can be broadly classified as true random number generators and pseudo random number generators. True random number generators add randomness from natural source, from noise, from electronic circuitry etc., whereas pseudo random number generators provide computer generated random number sequences.

Typically, random number generation is used for wide range of applications such as telecommunication systems, financial and healthcare services, IoT, automotive, consumer electronics, gaming, and sports. The random numbers are generated for various solutions such as key generation, one time password, digital tokens, digital signatures and certificates, encryption algorithms, random sampling, financial simulation, and model testing. Existing random number generation methods are based on classical computer algorithms or physical hardware which relies on mathematical unpredictability. The existing random number generators are not secure and cannot guarantee the quality of the random sequences.

Quantum random number generation are increasingly becoming popular for random number generation. A Quantum Random Number Generator (QRNG) makes use of the intrinsic or the inherent probabilistic nature of photons to construct random sequences often referred to as quantum random number. Randomness is also referred to as entropy, and hence quantum random number generators are also referred to as quantum entropy sources. In general, QRNG systems exploit the uncertainty principle of quantum mechanics to construct random bit sequences based on quantum optics characteristics and design random number generators using techniques like single photon detection, macroscopic detection etc.

The QRNG systems developed till now uses specialized hardware equipment's such as single photon sources, integrated electronics, optical control units, sensitive detectors. Such systems had some practical challenges and implementation drawbacks and further these systems are slow. For example, these devices cannot operate in different environments and there is no standard or uniformity in the hardware equipment's manufactures of these equipment's. The above mentioned technology challenges of the state of the art QRNG prevent them from becoming commercially viable systems for widespread applications. To overcome these short comings, researchers have explored the features of quantum shot noise or photon shot noise sources for harvesting the entropies of quantum origin. For example, such kind of inventions are disclosed in U.S. Pat. No. 9,747,077 B2, U.S. Pat. No. 10,635,403 B1 and U.S. Pat. No. 11,163,535 B1. The methods and systems disclosed in the prior arts, have significant challenges, in terms of lack of reliability, mistrust on the vendors, incompatibility and imperfections in the devices. Therefore, quantum random number generator systems require a dedicated infrastructure for a smooth operation, for example a temperature controlled, dark room infrastructure, which is difficult to provide in the real-world scenario. Further, controlling quantum devices used in the existing systems is hard and cannot guarantee the reliability and availability of quantum random sources. Due to the nature of quantum sources, it is not perfect always and difficult to generate genuinely random bits. Further, the trust and reliability of the randomness output is essential for all applications but there may be situations in which systems relay on single random source design.

Therefore, what is needed is a reliable, miniaturized, affordable and relatively simple quantum random number generator with excellent generation rate. Also, these systems should provide high security, designed to prevent tampering, and at the same time suitable to meet the needs of current industries is utmost important.

### BRIEF SUMMARY OF THE INVENTION

This summary is provided to introduce a selection of concepts in a simple manner that is further described in the detailed description of the disclosure. This summary is not intended to identify key or essential inventive concepts of the subject matter nor is it intended for determining the scope of the disclosure.

The present disclosure discloses a quantum random number generator for generating both true random sequences and pseudo random sequences, wherein the true random sequences are generated from a plurality of untrusted photon shot noise sources and extracted using a quantum randomness extraction module. Further, a pseudo random sequence is generated by multiplying two or more extracted true random sequences using a randomness amplification module wherein the random seed is from the plurality of untrusted photon shot noise sources.

The present invention take advantage of harvesting the randomness from the nature through shot noises of quantum origin. Various untrusted sources in this system randomly produces photons at an interval of time. Thus, it is impossible to perfectly define number of photons emitted per unit time. This quantum mechanical effect is often called quantum shot noise or photon shot noise.

The present disclosure discloses a system for generating quantum random number sequence. The system comprises a multisource quantum shot noise harvesting circuit, wherein the multisource quantum shot noise harvesting circuit comprises plurality of untrusted sources of noise. The multisource quantum shot noise harvesting circuit comprises a data acquisition module configured to receive quantum shot noises from the plurality of untrusted noise sources. The system comprises a randomness extraction module configured to extract the true quantum random sequence. The system comprises a randomness amplification module configured to multiply two or more true quantum random number sequence to generate pseudo random number sequences. The system comprises an oracle verification module to verify and certify the randomness of the outcome.

An objective of the present disclosure is to provide a system for quantum random number generation, wherein each system have two possible settings, where choosing each setting provides one of the two outcomes, i.e. a true random number or a pseudo random number. A true random number sequence will have more entropy whereas a pseudorandom number will have less entropy since it encompasses redundant true random number sequences. Based on the outcomes and its entropy levels, one can use the random numbers for crypto or non-crypto applications.

The present disclosure discloses a method for generating quantum random number sequence. The method comprises receiving quantum shot noises from a plurality of untrusted sources of noise and extracting a true quantum random number sequence from the quantum shot noises. The method comprises generating a pseudo random number sequence from two or more true quantum random number sequences. Further, the method comprises verify and certify the quantum randomness of the generated sequence.

To further clarify advantages and features of the present disclosure, a more particular description of the disclosure will be rendered by reference to specific embodiments thereof, which is illustrated in the appended figures. It is to be appreciated that these figures depict only typical embodiments of the disclosure and are therefore not to be considered limiting of its scope. The disclosure will be described and explained with additional specificity and detail with the accompanying figures.

### BRIEF DESCRIPTION OF THE FIGURES

The disclosure will be described and explained with additional specificity and detail with the accompanying figures in which:

FIG. 1 illustrates a system for generating quantum random number sequence, in accordance with an embodiment of the present disclosure;

FIG. 2 illustrates a multisource quantum shot noise harvesting circuit, in accordance with an embodiment of the present disclosure;

FIGS. 3A and 3B illustrates a dual mode operation of generating quantum random number sequence, in accordance with an embodiment of the present disclosure;

FIG. 4 illustrates a flowchart of a method for generating quantum random number sequence, in accordance with one embodiment of the present disclosure;

FIG. 5A illustrates data flow of generated random sequences from hardware to application level for true random number generation, in accordance with one embodiment of the present disclosure; and

FIG. 5B illustrates data flow of generated random sequences from hardware to application level for pseudo random number generation, in accordance with one embodiment of the present disclosure.

Further, persons skilled in the art to which this disclosure belongs will appreciate that elements in the figures are illustrated for simplicity and may not have been necessarily drawn to scale. Furthermore, in terms of the construction of the system for random number generation, it may have been represented in the figures by conventional symbols, and the figures may show only those specific details that are pertinent to understanding the embodiments of the present disclosure so as not to obscure the figures with details that will be readily apparent to those of ordinary skill in the art having benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications to the disclosure, and such further applications of the principles of the disclosure as described herein being contemplated as would normally occur to one skilled in the art to which the disclosure relates are deemed to be a part of this disclosure.

It will be understood by those skilled in the art that the foregoing general description and the following detailed description are exemplary and explanatory of the disclosure and are not intended to be restrictive thereof.

In the present disclosure, relational terms such as first and second, and the like, may be used to distinguish one entity from the other, without necessarily implying any actual relationship or order between such entities.

The terms “comprise”, “comprising”, or any other variations thereof, are intended to cover a non-exclusive inclusion, such that a process or method that comprises a list of steps does not include only those steps but may include other steps not expressly listed or inherent to such a process or a method. Similarly, one or more elements or structures or components preceded by “comprises . . . a” does not, without more constraints, preclude the existence of other elements, other structures, other components, additional devices, additional elements, additional structures, or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The components, methods, and examples provided herein are illustrative only and not intended to be limiting.

Quantum random number generators (QRNGs) are increasingly becoming the standard technique for random key generation because of its high security, even against a quantum computer. They are used for cryptographic applications as well as non-cryptographic applications. The present disclosure discloses a quantum random number generator for generating both true random sequences and pseudo random sequences, wherein the true random sequences are generated from multiple photon shot noise sources which are not perfect and are untrusted noise sources. The pseudo random sequences are generated using a quantum randomness amplification module. The system and method and various embodiments for quantum random number generation is further explained in the following description.

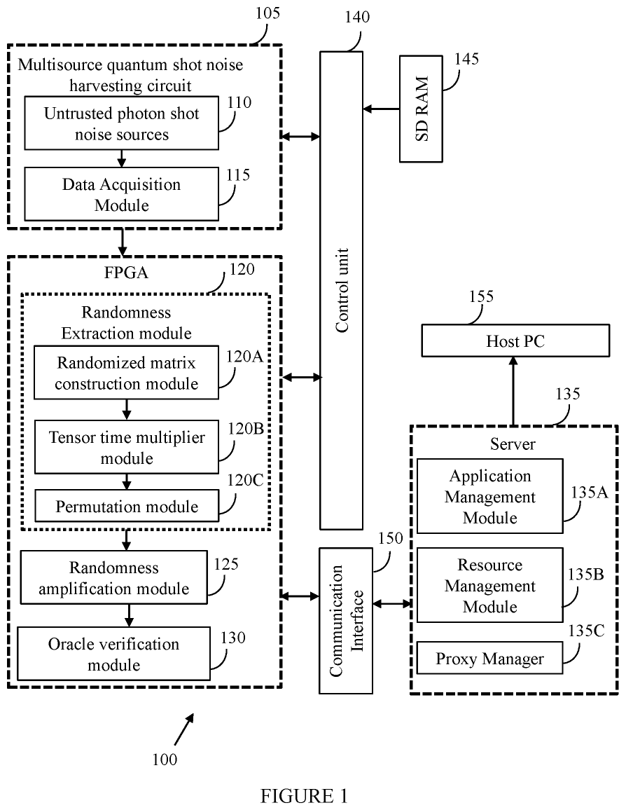

FIG. 1 illustrates a system 100 for generating quantum random number sequence, in accordance with an embodiment of the present disclosure. The system 100 is a hybrid system that includes both software and hardware modules, with some of the modules implemented in a printed circuit board (PCB) and some of the modules implemented in a Field Programmable Gate Array (FPGA). The system 100 includes a multisource quantum shot noise harvesting circuit 105. The multisource quantum shot noise harvesting circuit 105 includes a data acquisition module 115 configured to receive quantum shot noises from a plurality of untrusted photon shot noise sources 110. The multisource quantum shot noise harvesting circuit 105 is soldered in a PCB. In one embodiment, the untrusted photon shot noise sources 110 can be system on-chip photonic integrated circuits of dimension 5 mm×5 mm. Utilization of fairly priced off the shelf chip based shot noise sources significantly reduce the cost of the system without compromising quality of output random sequence.

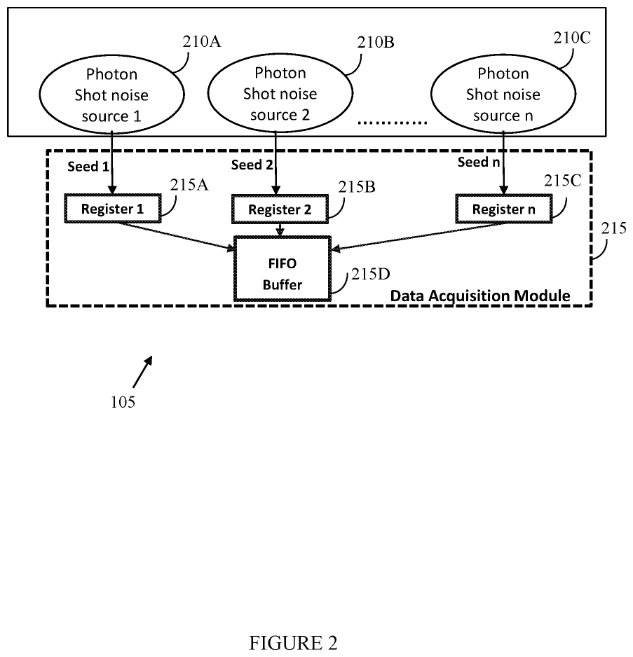

The multisource quantum shot noise harvesting circuit 105 includes a plurality of memory registers and a first in first out (FIFO) buffer. Further details of the memory registers and the FIFO buffer is explained in conjunction with FIG. 2.

Referring to FIG. 1, a control unit 140 captures random noises from multiple untrusted photon shot noise sources 110 and stores in the FIFO buffer. In general, the random data generation rate is directly proportional to the number of photon shot noise sources used in the system. In one example, data acquisition rate is upto 20 Mbps per source and if ten photon shot noise sources are combined together, then the data rate is upto 200 Mbps. In this scenario, true random number generation rate is upto 130 Mbps and pseudo random number generation rate is upto 2 Gbps.

The control unit 140 can configure sampling window from 0 to 100 ns and adjust noise harvesting rate. The control unit 140 reads the random noisy data from the chips using the standard serial peripheral interfaces. The data acquisition module 115 sends the data to a randomness extraction module 120 for further processing. The randomness extraction module 120 is configured to extract a true quantum random number sequence from the quantum shot noises. The randomness extraction module 120 purifies the noisy data to increase entropy of the true quantum random sequence. Extraction of the true quantum random sequences involve a series of tensor and permutation operations.

The randomness extraction module 120 includes a randomized matrix construction module 120A to transform the random noise sequence into a matrix. The randomness extraction module 120 includes a tensor time multiplier module 120B to improve the quality of random numbers by performing bitwise XORing and operation on the matrix. In other words, the tensor multiplication results in increasing the entropy of the random numbers. Further, the randomness extraction module 120 includes a permutation module 120C to perform random permutation operation on the matrix.

In one embodiment, randomized matrix construction module 120A employs widely used double-side Jacobi iteration method and the matrix elements of these units are stored in an on-chip memory to optimize the latency and throughput. All three components, i.e., the randomized matrix construction module 120A, the tensor time multiplier module 120B, the permutation module 120C are configured as a pipelined process to achieve the maximum efficiency. The randomized matrix construction module 120A is preconfigured with the standard matrix sizes and after the matrix construction, it moves the data between tensor time multiplier module 120 (TTM) and permutation module 120C. The TTM and permutation module 120C are implemented as a standard matrix to matrix tensor multiplication and random column wise and row wise permutation methods.

The randomness extraction module 120 also includes a processor and internal memory to store and retrieve the data and smooth execution of tensor time matrix multiplication operations and permutations. In addition, the randomness extraction process guarantees that the final outcome is completely uncertain, and it is hard to predict the future bit sequences by analyzing the current bit patterns. The outcome bit strings from the randomness extraction module 120 which is the true quantum random number sequence is fed into either user application modules or random amplification module 125, which amplifies the randomness and exponentially increases the data rate further based on the mode of system operation. The randomness amplification module 125 is configured to multiply two or more quantum random number sequence together to generate a pseudo random sequence. The amplification function is a black box Boolean circuit operation using the bit operations AND, OR and NOT. It is to be noted the final outcome (pseudo random sequence) will be sent to the user application. In other words, based on the user application requirement, either the true quantum random number sequence or the pseudo random number sequence can be provided.

The system 100 includes an oracle verification module 130 to verify and certify the random number sequence of quantum nature. The oracle verification module 130 is a crypto verification system that responds to every query with a random response chosen uniformly. The verification oracle in the present disclosure plays a major role in monitoring random bit sequences time to time and perform random statistical test on sampled data to evaluate the quality of the randomness. In general, random oracle engine or module is a crypto verification system that responds to every query with a random response chosen uniformly, expect that for any specific query, it responds the same way every time it receives that query. In other words, a random oracle is a function mapping every possible query to a random response from its output domain. The present invention is based on the standard random oracle verification circuit that ensures certain level of trust in order to generate the random numbers safely and efficiently. The oracle engine verifies one or more random values and provides proof for how those values were verified and certified. This ensures the users that the outcome of random number generator cannot be modified or manipulated by any external or internal entity including photon shot noise sources, expansion modules, device manufactures or attackers. The oracle verification module 130 also referred as random oracle engine in the present invention function as a black box (dynamic query engine) that, when queried, returns a single common value from a sample space. The value returned by an oracle may be independent of the input state that queried the random oracle at the time of the query.

The randomness extraction module 120, the randomness amplification module 125, and the oracle verification module 130 is configured in a FPGA. In one embodiment, the FPGA is connected to the printed circuit board soldered with one or more ICs, 32 Mb of SDRAM memory 145, 8 Mb of Flash memory and resolute control unit to manage the data acquisition module 115 and processing modules. However, it is to be noted that higher configurations of the various processors and memory cards are possible.

The system 100 includes a server 135. The server 135 includes an application management module 135A to manage generation of custom quantum random number sequence based on a plurality of user application requirements. The custom quantum random number sequence is one of a true quantum random number sequence or a pseudo random number sequence. The application management module 135A also manages delivery of a custom quantum random sequence to requested user application. The server 135 includes a resource management module 135B configured to dynamically allocate two or more on-chip quantum entropy sources based on availability, wherein the resource management module 135B facilitate the quantum random number sequence generation process to serve one or more service request from the application management module 135A. The server 135 also includes a proxy manger 135C designed to classify crypto user applications and non-crypto user applications and in conjunction with the application management module 135A delivers a tailor made random bit sequence.

Once the corresponding bit sequence passes the test by the oracle verification module 130, the produced random data is stored in an external memory. The application management module 135A is responsible for receiving one or more request form the users and deliver the random sequences or number based the requirements. In addition to that application management module 135A is enabled with intelligent systems which effectively extract the random bits from the memory unit and securely supplies it to user applications installed in a host PC or electronic device 155. The server 135 sends and receives date with the FPGA using any standard communication interface 150.

In one embodiment the server 135 is a hardware server located remotely, in another embodiment, the server 135 may reside on cloud. In one embodiment, the system 100 can be implemented as an on-premise box with plug and play functionality. In another embodiment, the system 100 can be implemented over a cloud network.

It is to be noted that the true quantum random number sequences are attributed with higher entropy and the pseudo random number sequence is attributed with lower entropy. The FPGA is programmable to make the system 100 operable in two modes: a first mode to provide true quantum random number sequence for user applications requiring high entropy random number sequences and a second mode to provide pseudo random number sequence for user applications requiring low entropy random number sequences.

FIG. 2 illustrates a multisource quantum shot noise harvesting circuit, in accordance with an embodiment of the present disclosure. Referring to FIG. 2, the multisource quantum shot noise harvesting circuit 105 includes a data acquisition module 215 configured to receive quantum random noises from a plurality of untrusted photon shot noise sources (210A, 210B . . . 210C) and to output a true quantum random sequence. The multisource quantum shot noise harvesting circuit 105 includes a plurality of memory registers (215A, 215B . . . 215C) and a first in first out (FIFO) buffer 215D. The random seed sources used in the present invention is shot noise based quantum entropies, which are generated from the quantum integrated circuit devices. These miniaturized chips are capable of producing upto 20 Mpbs using standard communication interfaces. The collected random seed data is stored in the corresponding register memory and transferred to FIFO buffer 215D for further processing. The seed data are processed in blocks of 512 bits and stored in the FIFO buffer 215D.

In addition, the control unit provides direct access to the register memory and each untrusted photon shot noise source is connected to memory control port in parallel mode. The memory controller has a FIFO buffer for each chip and facilitates simultaneous access to the memory. The internal memory along with FIFO buffer is managed by the centralized control unit (shown as 140 in FIG. 1) synchronized with data acquisition module 215. The input FIFO data are truncated to 16 bit in order to store the data in SDRAM (shown as 145 in FIG. 1) and to optimize the speed of the random number generation process.

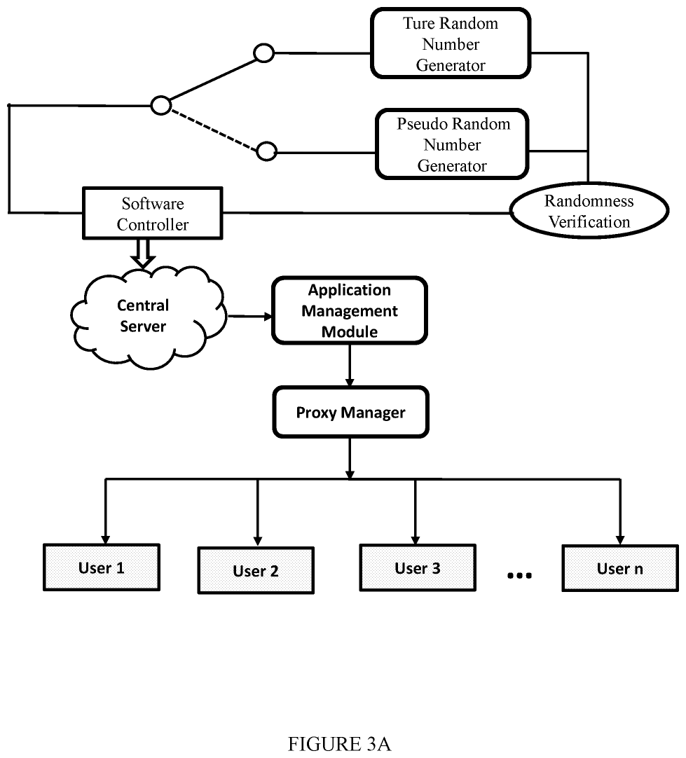

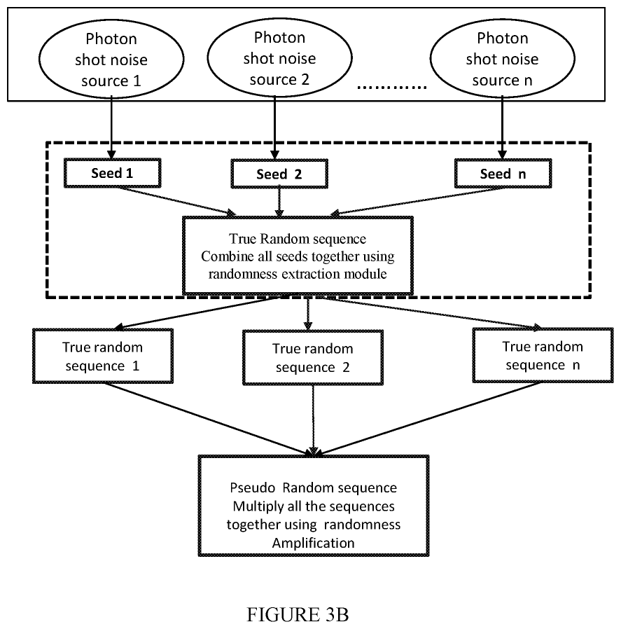

FIGS. 3A and 3B illustrates a dual mode operation of generating quantum random number sequence, in accordance with an embodiment of the present disclosure. In the present disclosure, a dedicated software control system enables switching between two modes of operation, including a first mode for true randomness when the random sequences are used for crypto-secure applications and a second mode for pseudo random number generation when there is a need for higher randomness in non-crypto applications. The system operation can be configured in any one of modes, for example a true random number generation operational mode can be one in which the system provides direct random sequence by merging the different random seeds together without applying any random bit expansion process. So outcome of such operational mode is directly proportional to the number of photon shot noise sources used in the system.

In ideal scenario, for example ten quantum noise sources with an average rate of 20 Mbps are used in the system, it can produce quantum random sequence rate upto 130 Mbps after the purification. A pseudorandom generation operational mode can be one in which the system applies non-deterministic methods in order to increase the bitrate. This mode operation promises to provide more than 2 Gbps for given ten photon shot noise used for generation.

The device operation is configured in two modes to switch from true random number sequence to pseudo random sequence and vice versa. Central sever through software controller can control one or more quantum random number generator device with different modes of operations. This helps to improve the data production rate and scalability. Randomness verification is an oracle model capable of verifying one or more request in parallel mode. In addition, central server and application manager can be implemented with intelligent techniques to manage the demand and supply process effectively. The proxy manger is designed to classify the crypto users and non-crypto user application segments and is responsible to deliver a tailor made random bit sequence.

As illustrated in FIG. 3B, multiple seeds are generated from multiple untrusted photon shot noise sources. The seeds are combined and then a true random sequence is extracted from the combined seed sequence. This true random sequence may be provided as the random number sequence for applications that require higher randomness, this is one mode of operation. From the extracted true random number sequence, further a pseudo random sequence is generated by multiplying “n” number of true random sequences. In one embodiment, “n” can be two true random number sequences. In another embodiment, “n” can be more than two true random number sequences. The pseudo random number sequence may be provide as the random number sequence in applications that require lower randomness, this is another mode of operation.

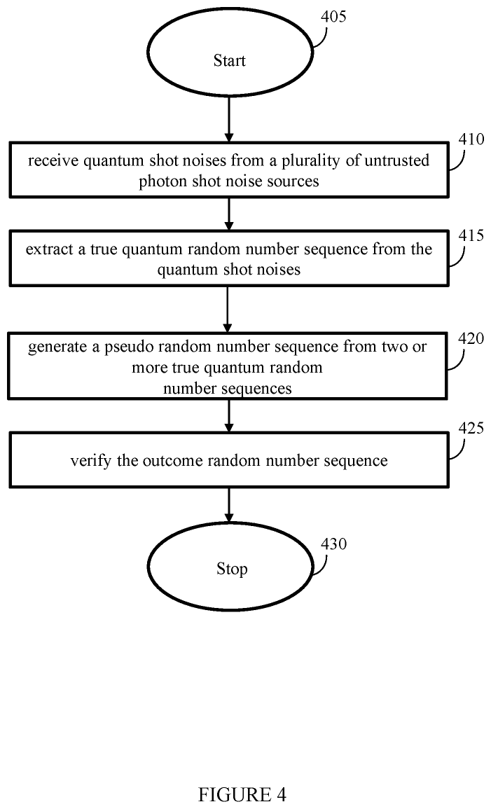

FIG. 4 illustrates a flowchart of a method for generating quantum random number sequence, in accordance with one embodiment of the present disclosure.

The method starts at step 405.

Step 410 includes receiving quantum noises from a plurality of untrusted photon shot noise sources. The on-chip quantum noise sources are embedded on a PCB. A data acquisition module on the PCB captures the quantum random noises from these sources.

Step 415 includes extracting a true quantum random number sequence from the quantum shot noises. At least two quantum random noises are captured by the data acquisition module operating in conjunction with a control unit also refereed as controller. Extracting the true quantum random sequence includes transforming the array of noisy data segment into a matrix, performing tensor multiplication operation on the matrix, and further performing random permutation on the matrix.

Step 420 includes multiplying two or more quantum random number sequence together to generate a pseudo random number sequence. The pseudo random number sequence can be the target random number for the specific user application. The method also includes generating customized quantum random number sequence based on the complexity of the user applications. There are two modes of operation based on user application requirements. A first mode of operation provides true quantum random number sequences, and a second mode of operation provides a pseudo random number sequence, based on the user application requirement.

Step 425 includes verifying and certifying all the random sequences produced by system. An oracle verification module cross checks and verifies if the random number sequence is true or not and further proceeds to certify the estimated randomness associated with particular sequence using entropy metrics.

The method stops at step 430.

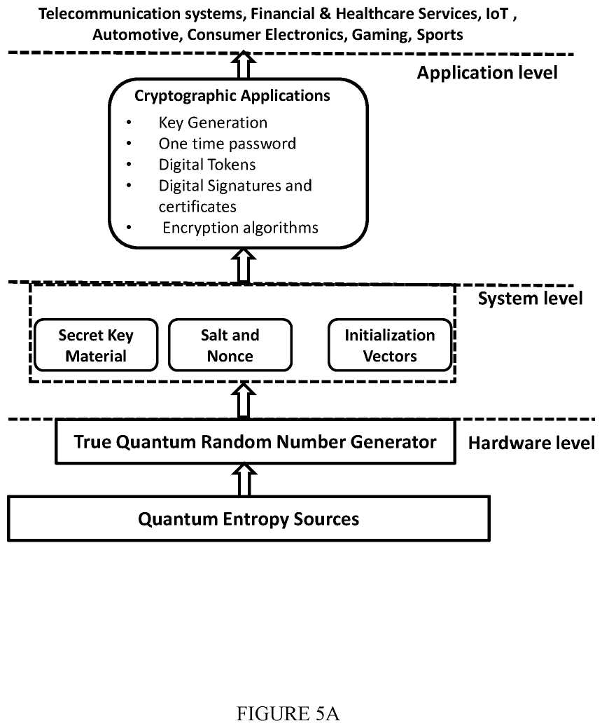

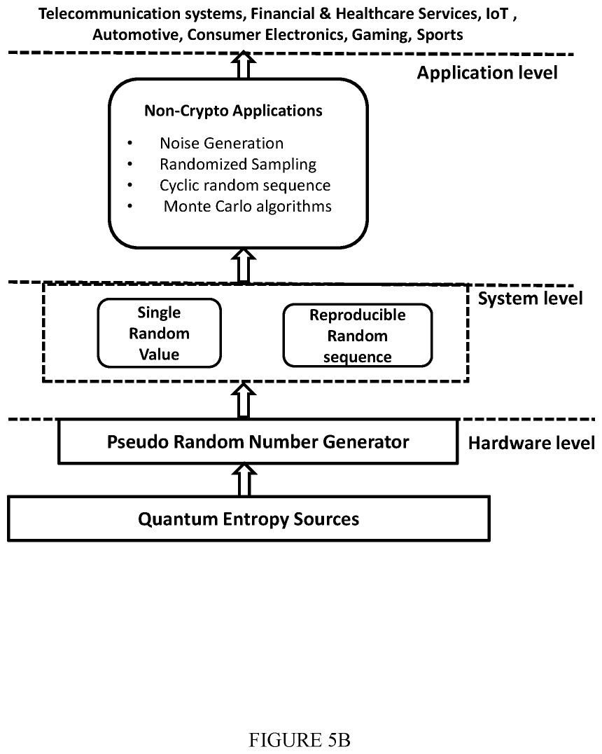

FIG. 5A illustrates data flow of generated random sequences from hardware to application level for true random number generation and FIG. 5B illustrates data flow of generated random sequences from hardware to application level for pseudo random number generation. Data flow can be easily mounted with different industry standard implementations at application layer. At this stage, a simple health and or randomness test can be performed to make sure the uninterrupted random number services to the user. Therefore, user can make a choice in selecting number of entropy sources that are required for the particular application and accordingly random data generation data will vary.

Some of the advantages of the QRNG system and device is provided below:

The QRNG device and system disclosed herein does not require use of bulky optical devices and since on-chip optical sources are used, the light source is stable.

The QRNG device and system disclosed herein is not affected by environment changes like ambient light condition and temperature variation.

The QRNG device and system disclosed herein provides high security from vulnerable hacking including hacking using quantum computers.

The present multisource, multimode, multipurpose quantum random number generation system offers a stable operation and increase the overall performance.

Device with two or more low cost photon shot noise sources are utilized for seed creation, which strengthens the overall security and reliability.

The present invention utilizes the imperfect, fairly priced untrusted photon shot noise sources for seeding, this significantly reduce the cost of the system without compromising quality of random sequence.

The assembly of the systems is more practical and easily portable and can provide out high rate of quantum random bit sequences.

The QRNG device and system disclosed herein is miniaturized hardware and energy efficient that can be integrated with other microelectronics and smart devices like one time password generators, mobile phone and other internet of thing's devices.

This is cost-effective solution compared to the state-of-the-art technologies and proven with better performance.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

We claim:

1. A system for generating quantum random number sequence, the system comprising:
a multisource quantum shot noise harvesting circuit, the multisource quantum shot noise harvesting circuit comprising a data acquisition module configured to receive quantum shot noises from a plurality of untrusted photon shot noise sources;
a randomness extraction module configured to extract a true quantum random number sequence from the quantum shot noises;
a randomness amplification module configured to multiply two or more true quantum random number sequence to generate a pseudo random number sequence; and
an oracle verification module to verify output random number sequence.

2. The system as claimed in claim 1, comprising a server, wherein the server comprises an application management module to manage:
generation of custom quantum random number sequence based on a plurality of user application requirements, wherein the custom quantum random number sequence is one of a true quantum random number sequence and a pseudo random number sequence; and
delivery of a custom quantum random sequence to requested user application.

3. The system as claimed in claim 2, wherein the server comprises a resource management module configured to dynamically allocate two or more untrusted photon shot noise sources based on availability, wherein the resource management module facilitate the quantum random number sequence generation process to serve one or more service request from the application management module.

4. The system as claimed in claim 2, wherein the server comprises a proxy manger designed to classify crypto user applications and non-crypto user applications and in conjunction with the application management module delivers a tailor made random bit sequence.

5. The system as claimed in claim 1, wherein the multisource quantum shot noise harvesting circuit comprises:
a plurality of memory registers; and
a first in first out (FIFO) buffer.

6. The system as claimed in claim 5, wherein a control unit captures quantum random noises from the plurality of untrusted photon shot noise sources and stores in the first in first out (FIFO) buffer.

7. The system as claimed in claim 1, wherein the randomness extraction module comprises:
a randomized matrix construction module to transform the discrete photon noise data into a matrix;
a tensor time multiplier module to increase randomness by performing bitwise XOR operation on the matrix; and
a permutation module to perform random permutation operation on the matrix.

8. The system as claimed in claim 1, wherein the true quantum random number sequences are attributed with higher entropy.

9. The system as claimed in claim 1, wherein the pseudo random number sequence is attributed with lower entropy.

10. The system as claimed in claim 1, wherein the randomness extraction module, the randomness amplification module, and the oracle verification module is configured in a Field Programmable Gate Array (FPGA).

11. The system as claimed in claim 10, wherein the FPGA is programmable to make the system operable in two modes:
a first mode to provide true quantum random number sequence for user applications requiring high entropy random number sequences; and
a second mode to provide pseudo random number sequence for user applications requiring low entropy random number sequences.

12. The system as claimed in claim 1, wherein the oracle verification module is a crypto verification system that responds to every query with a random response chosen uniformly.

13. The system as claimed in claim 1, wherein the oracle verification module certifies the random number sequence of quantum origin.

14. A method for generating quantum random number sequence, the method comprising:
receiving quantum shot noises from a plurality of untrusted sources of shot noise;
extracting a true quantum random number sequence from the discrete noise data matrix;
generating a pseudo random number sequence from two or more true quantum random number sequences; and
verifying and certifying quantum entropy of the output random number sequence.

15. The method as claimed in claim 14, comprising two modes of operation based on user application requirements, wherein a first mode of operation provides true quantum random number sequences, and a second mode of operation provides a pseudo random number sequence.

16. The method as claimed in claim 14, wherein extracting the true quantum random number sequence comprises transforming the true quantum random number sequence into a matrix.

17. The method as claimed in claim 16, wherein extracting the true quantum random number sequence comprises performing tensor multiplication operation on the matrix.

18. The method as claimed in claim 17, wherein extracting the true quantum random number sequence comprises performing random permutation on the matrix.
